(19) United States
(12) Patent Application Publication
(10) Pub. No.: US 2019/0303177 A1
(43) Pub. Date: Oct. 3, 2019

(54) Adaptive User Interface Based On Detection Of User Positions

(71) Applicant: Microsoft Technology Licensing, LLC, Redmond, WA (US)

(72) Inventors: Keren MASTER, Kfar Saba (IL); Eyal KRUPKA, Redmond, WA (US); Ido LEICHTER, Haifa (IL); Raz HALALY, Ness Ziyona (IL)

(21) Appl. No.: 15/940,852

(22) Filed: Mar. 29, 2018

(51) Int. Cl. G06F 9/451; G06T 7/73; G06K 9/00; G06F 3/0481

(52) U.S. Cl. CPC G06F 9/451; G06T 7/73; G06T 2207/30201; G06F 3/0481; G06K 9/00281

(57) ABSTRACT

In one embodiment, a computing system generates a reference distance to classify a user in a first position or a second position and measures a current distance of the user using a camera. The current distance measured using features of the user and the current distance is not a measurement of distance of the user to the camera. The computing system determines that the user is in one of the first position and the second position based on comparing the reference distance to the current distance. A user interface operates in a first mode when the user is in the first position and operates in a second mode when the user is in the second position.

### BACKGROUND

Applications are offering different interaction models for users to control the application. For example, with the increase in quality of speech detection and recognition, users can use speech to control or interact with applications, such as a digital assistant of a device or other types of applications. The use of speech may make it easier for the user to control the application in some instances. For example, a user may perform a search for information by speaking a command. This allows the user to not have to physically type in the search and also the user may be free to move farther away from the device. In some examples, the device may also have a display screen that may display search results. Given that the user is using voice commands, the user may or may not be close enough to the screen to read the results. This may limit the usefulness of using the display screen especially when the user has moved farther away from the device.

### BRIEF DESCRIPTION OF THE DRAWINGS

FIG. 1 depicts an example of a computing system for controlling an adaptive user interface according to some embodiments.

FIG. 2A depicts a user who is in a lean forward position according to some embodiments.

FIG. 2B depicts an example of a user in a lean back position according to some embodiments.

FIG. 3 depicts a simplified flow chart of a method for controlling the user interface according to some embodiments.

FIG. 4 depicts a simplified flowchart of a method for calculating a reference distance or a current distance according to some embodiments.

FIG. 5A depicts an example of a measurement when the user is in a lean back position according to some embodiments.

FIG. 5B depicts an example of a measurement when the user is in a lean forward position according to some embodiments.

FIG. 6 depicts an example of the computing system for adapting the user interface according to some embodiments.

FIG. 7 depicts a simplified block diagram of an example computer system according to certain embodiments.

### DETAILED DESCRIPTION

The present technology comprises a computing system that uses a camera, such as a red/green/blue (RGB) camera or a black and white (B/W) gray scale camera, to determine a user position, such as a posture. Based on the user position and a relative distance, some embodiments may dynamically adapt a user interface to enable different modes, such as a first mode and a second mode. The first mode may be a lean forward mode where the system determines that the user is near the display and the second mode may be a lean back mode where the system determines that the user is farther from the display, but looking at the display. Based on the currently enabled mode, the user interface may behave differently. For example, when the user is in a lean forward mode, the user interface may be displayed in a lean forward view that may format the user interface such that a user can read or see the content of the user interface from a position that is close to the display. For example, the user interface may change by adding some data displayed on the user interface, decreasing the font size, changing to a partial-screen view, changing the behavior of the application (e.g., turning a screen on), changing the image size to be smaller, zooming out for a map view, changing the amount of data for visual new headlines, playing lyrics, adding menus that were minimized, etc. When the user is in a lean back mode, the user interface may be displayed in a lean back view that may adjust the user interface such that the user can read or see the content of the user interface from a position farther away from where the user was in the lean forward mode. For example, the user interface may change by removing some data displayed on the user interface, increasing the font size of text, removing menus, changing the behavior of the application (e.g., turning off a screen), changing the image size to be larger, zooming in for a map view, changing the amount of data for visual new headlines, removing lyrics, changing to a full-screen mode that is visible from afar, etc.

In some embodiments, the computing system uses a camera that may not be able to directly measure depth, such as the distance of an object from the camera. However, such a camera can measure changes in relative distance in a two dimensional space by computing a reference distance and then comparing current measured distances to the reference distance. An image in two dimensional space does not have a depth (z axis) dimension. In some embodiments, the computing system may generate a reference distance that is used as a boundary to classify the user as being in a first position (e.g., the lean forward position) or second position (e.g., the lean back position). In some embodiments, the computing system measures the reference distance by measuring the distance (e.g., number of pixels) between the outer corners of the two eyes of a user and dividing that measurement by the cosine of the yaw of the user's head. Once the reference distance is generated, then at times, the computing system measures a current distance of the user using the camera. The current distance may vary depending on whether the user moves back or forth to be farther or closer to the camera and/or rotates his/her head. The computing system then compares the current distance with the reference distance to determine whether the user is in the lean forward position or the lean back position. For example, if the current distance is greater than the reference distance, the computing system determines that the user is in the lean forward position, and if the current distance is less than or equal to the reference distance, then the computing system determines that the user is in the lean back position. It will be understood that different comparisons to the reference distance may be used to determine whether the user is in the lean back position, such as if the current distance is less than the reference distance, then the computing system determines that the user is in the lean back position. Based on comparison, the computing system may change the operating mode of the user interface as the user's position changes, such as changing from the lean forward view to the lean back view when the user moves from the lean forward position to the lean back position, or changing from the lean back view to the lean forward view when the user moves from the lean back position to the lean forward position.

System Overview

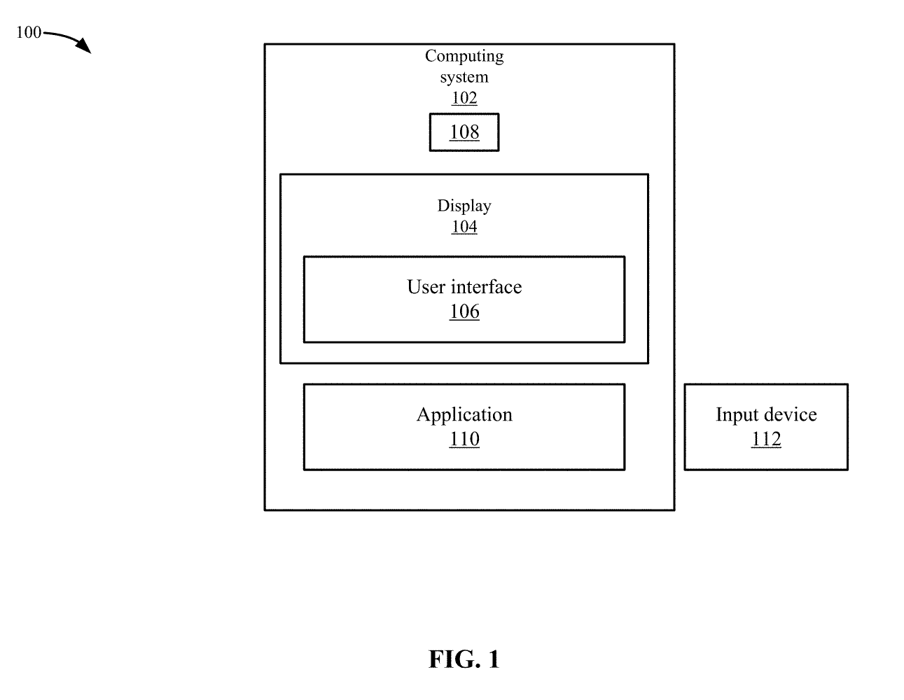

FIG. 1 depicts an example of a computing system 102 for controlling an adaptive user interface 106 according to some embodiments. Computing system 102 may be a laptop computer, personal computer, tablet, cellular phone, smart speaker, or other device that has a camera 108 or is connected to a camera. Also, computing system 102 may include distributed parts, such as display 104 or an input device 112 that is separate from hardware that is executing application 110.

An application 110 may be running on computing system 102 and controls user interface 106, which may display content from application 110. User interface 106 may be displayed on a display 104 of computing system 102. For example, user interface 106 may be a window that is displayed on a monitor. As will be discussed in more detail below, user interface 106 may be adaptable and operate in different modes.

A user may use an input device 112, such as a keyboard, mouse, microphone, touchscreen, etc., to interact with application 110. For example, a user may speak commands that are recognized by input device 112. In other examples, a user may use a mouse to control application 110 or may touch display 104. Input device 112 may be built in to computing system 102 (e.g., a touchscreen) or may be connected to computing system 102 (e.g., a mouse). In some examples, input device 112 is situated in a position such that a user can interact with input device 112 while viewing display 104. The user may use input device 112 to control user interface 106, such as by increasing the window size of user interface 106, or control the properties (e.g., font size, menus) of user interface 106.

In some embodiments, camera 108 may be a web camera that is attached to computing system 102. In other examples, camera 108 may be a separate camera that is connected to computing system 102. Camera 108 may capture video in a field of view. For example, camera 108 may capture a series of images of a user when the user is in the camera's field of view.

In some embodiments, camera 108 is a capture device that cannot measure depth directly. That is, the captured video includes images that are flat and not three dimensional (3-D). In some embodiments, camera 108 is an RGB camera or B/W camera that can measure distances in the flat image, but not depth. The RGB camera captures video in color and the B/W camera captures video in black and white. Although an RGB or B/W camera is discussed, it will be understood that other cameras that cannot measure depth may be used. Camera 108 may not have features to measure depth. However, in other embodiments, camera 108 may be able to measure depth, but the depth measurements are not used in determining the mode of user interface 106. Rather, computing system 102 uses the process described below to determine the mode.

Some embodiments understand how a user is positioned using images captured from camera 108. The analysis may be performed by analyzing the images to determine when a user is in a first position, such as a lean forward position, or a second position, such as a lean back position. Then, application 110 can dynamically adjust the operating mode of user interface 106. This enables a new interaction model for application 110 by detecting a user's position and then adapting user interface 106 to operate in different modes. For example, if a user is farther away while interacting with application 110, application 110 can operate user interface 106 in the lean back mode. For example, a user may display a recipe on user interface 106. When the user is farther away from the user interface 106, application 110 can increase the font of the content being displayed or change user interface 106 to a full screen view. When the user is closer to user interface 106, application 110 can decrease the font because the user is closer and can most likely read the smaller font-size content, which may allow more content to be displayed at a time. Although two positions are described, more than two positions may be used. For example, a lean forward position, a mid-range position, and a lean back position may be used. This would require two reference distances to be calculated to be used between the lean forward position and the mid-range position and between the mid-range position and the lean back position.

The adaptable interface provides an improved user interface by detecting the interaction of the user position and automatically adapting the operating mode of user interface 106. The changing between modes of user interface 106 may be performed automatically without a user specifying in which mode the user would like to operate. The dynamic adaptation of user interface 112 improves the display of user interface 106 by detecting a mode in which a user most likely would want the user interface 106. The dynamic adaption also removes the necessity of requiring an input command from the user. For example, the user may be used to increasing the size of the font by touching display 104. However, if the user is in the lean back position and cannot reach display 104, then the user might have to move forward to touch display 104 to increase the font size or maximize the window. The automatic adaption of user interface 102 reduces the amount of input needed by the user to adjust user interface 106.

The adaptable interface also uses a process that does not require camera 108 to measure depth in a three dimensional space. Some computing systems, such as smart speakers, tablets, and cellular phones, may not be equipped with cameras that can measure depth. The process of determining the user position described herein does not require a camera to measure depth and allows the changing of modes in computing systems that may have smaller displays, which increases the value of the adaptable user interface because content on these displays may be harder to read or otherwise interact with from farther distances and it may be more likely that a user is moving around.

Different User Positions

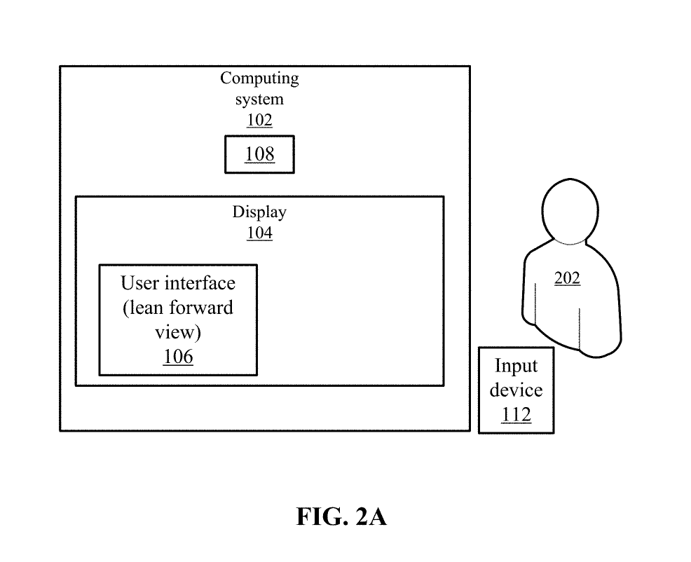

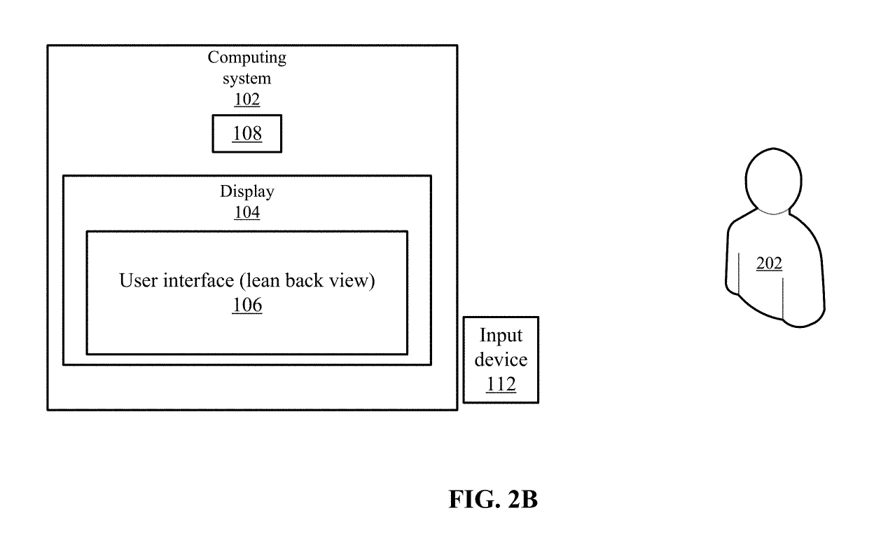

FIGS. 2A and 2B show the different modes of user interface 106 and different positions of the user according to some embodiments. A user 202 is shown and can be in different positions, such as different distances from camera 108.

FIG. 2A depicts a user who is in a lean forward position according to some embodiments. For purposes of this discussion, a reference distance is used that marks a boundary between a lean forward position and a lean back position. In some embodiments, the lean forward position may be defined as when at least part of the user (e.g., the user's face) is within the camera field of view and the user's hands are within reach of input device 112. For example, the user is touching input device 112 when the reference distance is calculated.

In FIG. 2A, a user is in a position where the user can reach input device 112 (e.g., closer than the reference distance). In this example, camera 108 captures an image of the user. Computing system 102 detects the position of the user and determines the user is closer than the reference distance. Upon determining the user is in the lean forward position, application 110 can enable the lean forward mode of user interface 106. As can be seen, user interface 106 is in a lean forward mode of display 104, which may be a partial screen view or a view with a smaller font compared to the lean back mode.

FIG. 2B depicts an example of a user in a lean back position according to some embodiments. In this example, the user is in a position where the user cannot reach input device 112 (e.g., a distance greater than the reference distance). Camera 108 captures an image of the user and computing system 102 determines the user is farther than or equal to the reference distance. Then, application 110 can adapt user interface 106 to be in the lean back mode. For example, the lean back mode may cause user interface 106 to be in a full screen view or a view with a larger font compared to the lean forward mode.

User Interface Control

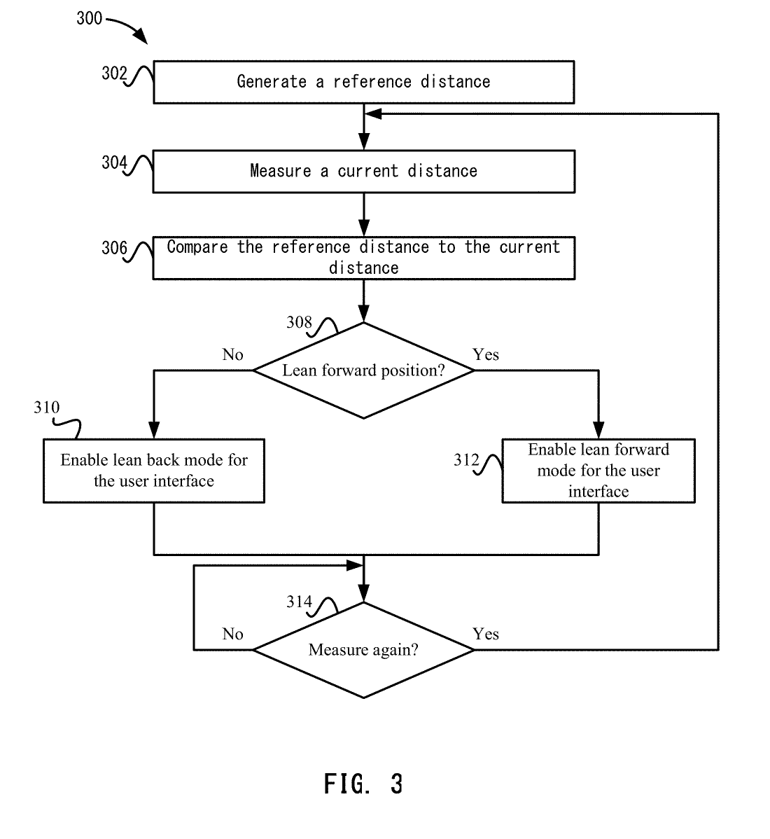

FIG. 3 depicts a simplified flow chart 300 of a method for controlling user interface 106 according to some embodiments. At 302, computing system 102 generates a reference distance. The reference distance may be a distance that is used to determine whether the user is in the lean forward position or the lean back position. The reference distance may vary based upon which user is using computing system 102. For example, the reference distance may depend upon a user's body structure and personal preference, such that a taller user may have a reference distance that is farther away from the camera than a shorter user. In some embodiments, computing system 102 may generate the reference distance once, such as when it detects that the user is touching input device 112 or can reach input device 112. For example, computing system 102 may measure the reference distance from an image of the user when the user is touching input device 112. In other embodiments, the reference distance may be preset by a user or be based on a prior reference distance calculation. Also, computing system 102 may measure the reference distance when the user is not touching the computing system because the user may typically speak commands. In this instance, computing system 102 may detect when a user can reach input device 112 by measuring the strength (e.g., volume) of a user's voice.

At 304, at later times, computing system 102 may measure a current distance. For example, at certain time intervals or when certain events occur, computing system 102 may measure the current distance. The events could include a new application being launched; in-focus application changes; input is required from an application; the user is detected as moving; etc. In some embodiments, camera 108 may be continuously capturing video or images of the user. Computing system 102 may only use some images from the video or series of images to calculate the current distance. For example, computing system 102 may enable camera 108 when the time interval or event occurs, which may more efficiently use camera 108 and maintain privacy for the user. However, in other embodiments, computing system 102 may measure the current distance continuously. In some embodiments, a user may set preferences as to when the current distance is measured.

At 306, computing system 102 compares the reference distance to the current distance. In some embodiments, the comparison may determine whether the current distance is greater or less than the reference distance. If the current distance is greater than the reference distance, then the user is determined to be farther away from camera 108; and if the current distance is less than the reference distance, then the user is determined to be closer to camera 108 compared to when the reference distance was measured.

At 308, computing system 102 determines whether the user is in a lean forward position. If the user is not in the lean forward position, at 310, application 110 enables the lean back mode for user interface 106. If user interface 106 was in a lean forward mode, then application 110 dynamically changes user interface 106 to the lean back mode, such as changing user interface 106 from the partial screen view to the full-screen view.

If computing system 102 determines the user is in the lean forward position, then at 312, application 110 enables the lean forward mode for user interface 106. Similar to the above, if user interface 106 was in the lean back mode, then application 110 dynamically enables the lean forward mode, such as changing user interface 106 from the full-screen view to the partial-screen view. If user interface 106 was already in the lean forward mode, application 110 does not change the view.

At 314, computing system 102 then determines whether to measure the current distance again. For example, computing system 102 may wait another time interval, such as one minute, to measure the current distance again. Or, computing system 102 may wait for an event to occur, such as the user speaking a command. When it is time to measure again, the process reiterates to 304 to measure the current distance again. Application 110 may then again dynamically adapt the mode of user interface 106 based on the current distance.

Distance Calculation

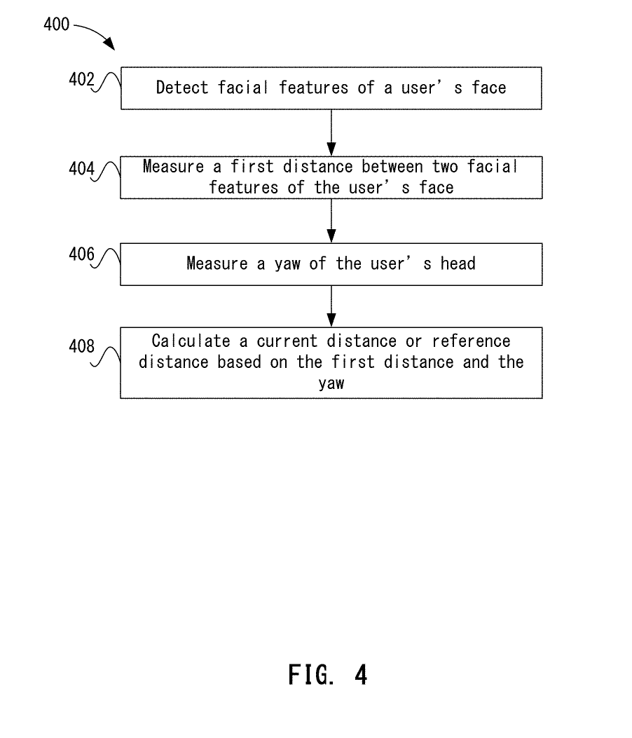

FIG. 4 depicts a simplified flowchart 400 of a method for calculating the reference distance or the current distance according to some embodiments. Although this calculation is described, it will be understood that other calculations may be used.

At 402, computing system 102 detects features of a user. In some embodiments, computing system 102 detects facial features of the user, such as the user's eyes. However, other features may be used, such as the user's ears, arms, etc. To detect the features, computing system 102 may receive an image or video from camera 108. Camera 108 may have a field of view that defines what is captured in an image at any given moment. In some examples, computing system 102 detects whether a user's face is fully present in the field of view before analyzing whether the mode should be changed. When a user's face is not fully within the field of view, then computing system 102 may not analyze whether the mode should be changed because the measurement of the current distance may not be accurate.

At 404, computing system 102 measures a first distance between two features of the user, such as the distance between the user's two eyes. For example, computing system 102 may measure a distance (e.g., the number of pixels) between outer corners of the two eyes. Although the outer corners of the two eyes is described, other distances may be used, such as a distance between the inner corners of the two eyes, a distance between the center of the two eyes, a distance between the ears of the user, etc.

At 406, computing system 102 then measures a yaw of the user's head. The yaw may be the rotational distance around a yaw axis. For example, the yaw may measure the rotation of the user's face around a yaw axis that comprises the middle of the user's head. The yaw is used because the user can rotate his/her face, which may affect the measurement distance between the eyes. For example, if the distance between the user's eyes is measured while the user is looking straight at the camera and then the user turns his/her head, the distance between the user's eyes is different, even though the user has not moved closer to or further away from the camera. Using the yaw normalizes the distance measurement when the user rotates his head.

At 408, application 110 calculates a current distance or reference distance based on a first distance and the yaw. For example, application 110 may divide the first distance by the cosine of the yaw.

Although the distance between the user's eyes and the yaw is described, other measurements to determine the relative distance of a user may be used. For example, any measurement that can quantify a distance relative to a reference distance when a user moves closer to or farther from camera 108 may be used.

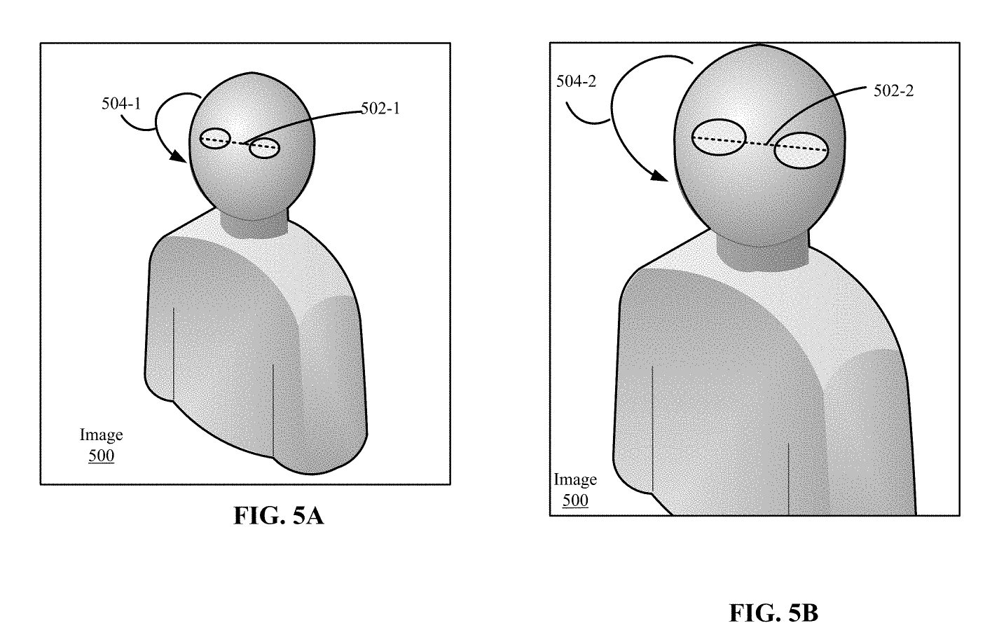

FIGS. 5A and 5B depict examples of different measurements according to some embodiments. FIG. 5A depicts an example of a measurement when the user is in a lean back position according to some embodiments. An image 500 displays a user. A distance 502-1 is shown between the outer edges of the user's eyes. Also, the yaw measurement is shown at 504-1. The yaw measures the rotation of the user's head.

FIG. 5B depicts an example of a measurement when the user is in the lean forward position according to some embodiments. The distance between the outer edges of the user's eyes is shown at 502-2 and the yaw is shown at 504-2 Additionally, the yaw may be the same or different depending on whether the user has rotated his/her head. In FIG. 5B, the user is closer to camera 108 and the distance between the outer edges of the eyes is greater. Assuming the user has not rotated his/her head, the distance at 502-2 is larger than the distance at 502-1. The larger distance indicates that the user is closer to camera 108 compared to when a smaller distance is calculated. Accordingly, the user in FIG. 5B is closer to camera 108 compared to the user shown in FIG. 5A.

The above calculation uses a relative distance comparison to determine the user's position. Camera 108 does not need to detect the depth of the user relative to the camera. Accordingly, some embodiments can be used in computing systems that do not have cameras capable of detecting depth. These types of devices may be devices that users more commonly use when moving around, such as tablet devices, smart speakers with displays, cellular phones, etc. These types of devices can then benefit from the enhanced operation of user interface 102. In some embodiments, the dynamic adaption may be useful when using these types of devices. For example, a user may be moving back and forth when using a smart speaker, such viewing or listening to recipe steps while cooking a meal. As the user moves farther away from the smart speaker, user interface 102 may automatically increase the font or volume, making it easier for the user to view and/or hear the recipe.

Example Implementation of a Computing System

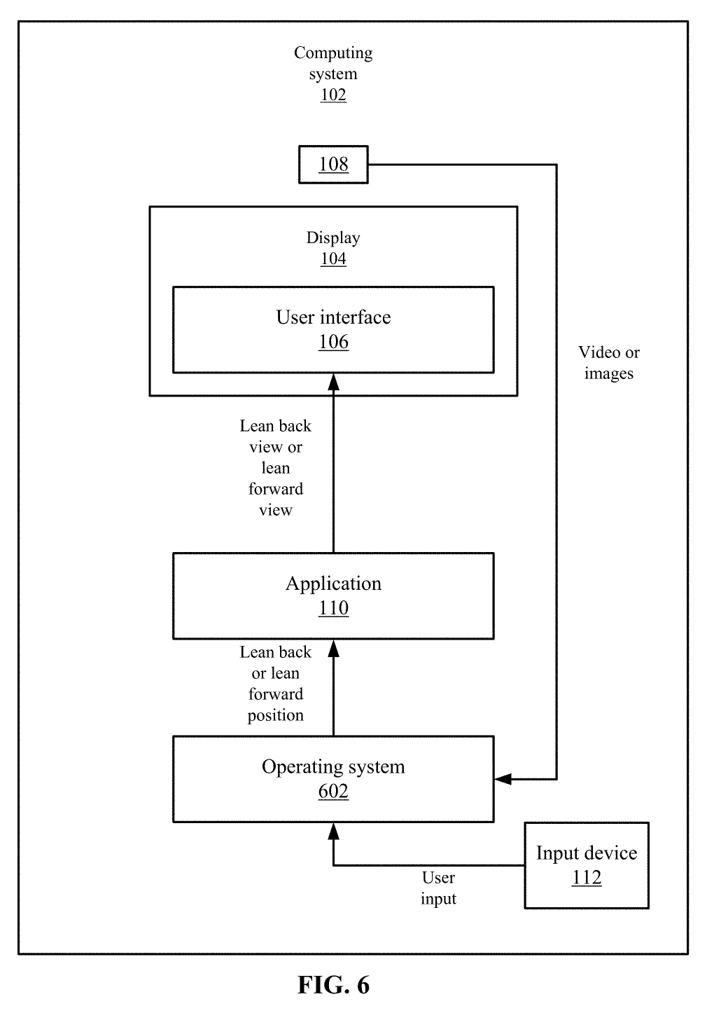

FIG. 6 depicts an example of computing system 102 for adapting user interface 112 according to some embodiments. An operating system 602, application 110, or another system may perform the calculation of the user position. Operating system 602 may be software running on hardware of computing system 102 and manages the hardware and software of computing system 102. Application 110 may be running on operating system 602 and may display content on user interface 106.

In some embodiments, operating system 602 receives video or images from camera 108. Also, operating system 602 may detect user input from input device 112. Then, operating system 602 may calculate the reference distance when an input is detected from input device 112 by analyzing an image of the user as described above. It will be understood that operating system 602 needs to detect the user in the image to perform the calculation. If the user is not in the field of view, then operating system 602 may not perform the calculation. Operating system 602 may perform this calculation because the operating system may have access to the input and video from camera 108 while application 110 may not, and thus operating system 602 may be able perform the calculations. However, operating system 602 may forward the video and the input to application 110 to allow application 110 to perform the calculations.

Thereafter, operating system 602 continues to receive video or images and can calculate the current distance of the user. Operating system 602 calculates the current distance when the user is in the field of view of camera 108. Operating system 602 then determines whether the user is in the lean back or lean forward position. Once again, application 110 may perform this calculation. Once determining the user position, operating system 602 sends a signal to application 110 indicating the user's position. For example, operating system 602 sends a signal that the user is in the lean back or lean forward position.

Application 110 may adapt user interface 106 based on the user position. For example, application 110 may perform an operation internal to application 110. That is, application 110 may adjust settings that application 110 has control over, such as minimizing menus of user interface 106 or increasing the font size. Application 110 may also perform operations external to it, such as transitioning from a partial screen view to a full screen view. The external operation may require that application 110 communicate with operating system 602 to perform the operation, such as maximizing the window may require communication with operating system 602.

The action taken to adapt user interface 106 may be an action that is not supported by user input to computing system 102. For example, one interaction model, such as voice interaction, may not allow the user to increase the size of the font or the window size via voice. Also, the action may be supported by another interaction model, such as the user may increase the font via touch. However, the use of the lean back or lean forward mode may use an internal command to increase the font size without requiring any touch input from the user.

### CONCLUSION

Accordingly, application 110 makes the system independent of physical distance between the two facial features in a three-dimensional space, and thus independent of the specific subject and the camera's intrinsic specifications. This allows application 110 to predict the position of the user without being able to measure the current depth of the user from camera 108. This enables computing system 102 to use a camera that is not configured to detect depth. When using some devices, such as smart speakers, cellular phones, or other devices that do not have cameras that can detect depth, application 110 enables the adaptive nature of user interface 106 by inferring the user's relative position.

Example Computer System

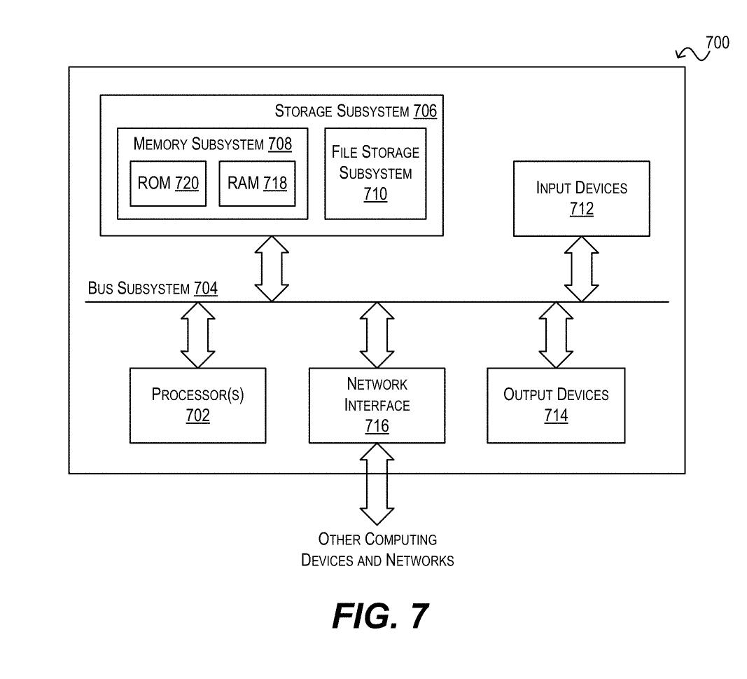

FIG. 7 depicts a simplified block diagram of an example computer system 700 according to certain embodiments. Computer system 700 can be used to implement any of the computing systems, systems, or servers described in the foregoing disclosure. As shown in FIG. 7, computer system 700 includes one or more processors 702 that communicate with a number of peripheral devices via a bus subsystem 704. These peripheral devices include a storage subsystem 706 (comprising a memory subsystem 708 and a file storage subsystem 710), user interface input devices 712, user interface output devices 714, and a network interface subsystem 716.

Bus subsystem 704 can provide a mechanism for letting the various components and subsystems of computer system 700 communicate with each other as intended. Although bus subsystem 704 is shown schematically as a single bus, alternative embodiments of the bus subsystem can utilize multiple busses.

Network interface subsystem 716 can serve as an interface for communicating data between computer system 700 and other computer systems or networks. Embodiments of network interface subsystem 716 can include, e.g., an Ethernet card, a Wi-Fi and/or cellular adapter, a modem (telephone, satellite, cable, ISDN, etc.), digital subscriber line (DSL) units, and/or the like.

User interface input devices 712 can include a keyboard, pointing devices (e.g., mouse, trackball, touchpad, etc.), a touch-screen incorporated into a display, audio input devices (e.g., voice recognition systems, microphones, etc.) and other types of input devices. In general, use of the term “input device” is intended to include all possible types of devices and mechanisms for inputting information into computer system 700.

User interface output devices 714 can include a display subsystem, a printer, or non-visual displays such as audio output devices, etc. The display subsystem can be, e.g., a flat-panel device such as a liquid crystal display (LCD) or organic light-emitting diode (OLED) display. In general, use of the term “output device” is intended to include all possible types of devices and mechanisms for outputting information from computer system 700.

Storage subsystem 706 includes a memory subsystem 708 and a file/disk storage subsystem 710. Subsystems 708 and 710 represent non-transitory computer-readable storage media that can store program code and/or data that provide the functionality of embodiments of the present disclosure.

Memory subsystem 708 includes a number of memories including a main random access memory (RAM) 718 for storage of instructions and data during program execution and a read-only memory (ROM) 720 in which fixed instructions are stored. File storage subsystem 710 can provide persistent (i.e., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computer system 700 is illustrative and many other configurations having more or fewer components than system 700 are possible.

The above description illustrates various embodiments of the present disclosure along with examples of how aspects of these embodiments may be implemented. The above examples and embodiments should not be deemed to be the only embodiments, and are presented to illustrate the flexibility and advantages of the present disclosure as defined by the following claims. For example, although certain embodiments have been described with respect to particular process flows and steps, it should be apparent to those skilled in the art that the scope of the present disclosure is not strictly limited to the described flows and steps. Steps described as sequential may be executed in parallel, order of steps may be varied, and steps may be modified, combined, added, or omitted. As another example, although certain embodiments have been described using a particular combination of hardware and software, it should be recognized that other combinations of hardware and software are possible, and that specific operations described as being implemented in software can also be implemented in hardware and vice versa.

The specification and drawings are, accordingly, to be regarded in an illustrative rather than restrictive sense. Other arrangements, embodiments, implementations and equivalents will be evident to those skilled in the art and may be employed without departing from the spirit and scope of the present disclosure as set forth in the following claims.

What is claimed is:

1. A computer system comprising:
a processor; and
a computer readable storage medium having stored thereon program code that, when executed by the processor, causes the processor to:
generate a reference distance to classify a user in a first position or a second position;
measure a current distance associated with the user using a camera, the current distance measured using features of the user, wherein the current distance is not a measurement of a distance between the user and the camera;
determine that the user is in one of the first position or the second position based on comparing the reference distance to the current distance; and
when it is determined that the user is in the first position, cause a user interface to operate in a first mode; and
when it is determined that the user is in the second position, cause the user interface to operate in a second mode.

2. The computer system of claim 1, wherein measuring the current distance associated with the user comprises:
determine a first measurement between two facial features of a face of the user;
determine a second measurement of a rotation of the face of the user; and
use the first measurement and the second measurement to measure the current distance.

3. The computer system of claim 2, wherein:
the two facial features comprise two eyes of the user, and
the rotation of the face is a yaw measurement of the face of the user.

4. The computer system of claim 3, wherein using the first measurement and the second measurement to measure the current distance comprises:
dividing the first measurement between the two eyes of the user by the yaw measurement.

5. The computer system of claim 1, wherein determining that the user is in one of the first position or the second position based on comparing the reference distance to the current distance comprises:
determine that the current distance is greater than the reference distance; and
determine that the user is in the first position that is nearer to the user interface compared to a third position of the user when the reference distance was calculated.

6. The computer system of claim 1, wherein determining that the user is in one of the first position or the second position based on comparing the reference distance to the current distance comprises:
determine that the current distance is less than the reference distance; and
determine that the user is in the second position that is farther from the user interface compared to a third position of the user when the reference distance was calculated.

7. The computer system of claim 1, wherein the first position is determined to be closer to an input device than the second position.

8. The computer system of claim 1, wherein the camera cannot measure depth.

9. The computer system of claim 1, wherein the reference distance is generated when it is detected that the user is using an input device.

10. The computer system of claim 1, wherein the program code further causes the processor to:
cause the user interface to change operation from the first mode to the second mode when the user changes from the first position to the second position, and cause the user interface to change operation from the second mode to the first mode when the user changes from the second position to the first position

11. The computer system of claim 1, wherein:
causing the user interface to operate in the first mode comprises causing the user interface to operate in a partial screen view, and
causing the user interface to operate in the second mode comprises causing the user interface to operate in a full screen view in.

12. The computer system of claim 1, wherein:
causing the user interface to operate in the first mode comprises causing the user interface to decrease a size of features in the user interface, and
causing the user interface to operate in the second mode comprises causing the user interface to increase the size of the features in the user interface.

13. The computer system of claim 1, wherein:
causing the user interface to operate in the first mode comprises causing the user interface to remove an item in the user interface, and
causing the user interface to operate in the second mode comprises cause the user interface add an item in the user interface.

14. The computer system of claim 1, wherein:
the first position is when the user is determined to be within a field of view of the camera and within reach of an input device, and
the second position is when the user is determined to be within the field of view of the camera and not within reach of an input device.

15. The computer system of claim 1, wherein:
causing the user interface to operate in the first mode comprises sending a signal from an operating system of the computer system to an application running on the computer system to cause the user interface to operate in the first mode, and
causing the user interface to operate in the second mode comprises sending a signal from the operating system of the computer system to the application running on the computer system to cause the user interface to operate in the second mode.

16. The computer system of claim 15, wherein:
causing the user interface to operate in the first mode comprises performing an operation internal to the application to cause the user interface to operate in the first mode, and
causing the user interface to operate in the second mode comprises performing an operation internal to the application to cause the user interface to operate in the second mode.

17. The computer system of claim 1, wherein the first mode or the second mode is configured to perform an operation not supported by an input device.

18. A method comprising:
generating, by a computing system, a reference distance to classify a user in a first position or a second position;
measuring, by the computing system, a current distance associated with the user using a camera, the current distance measured using features of the user, wherein the current distance is not a measurement of a distance between the user and the camera;
determining, by the computing system, that the user is in one of the first position or the second position based on comparing the reference distance to the current distance; and
causing, by the computing system, a user interface to operate in a first mode when the user is in the first position and causing the user interface to operate in a second mode when the user is in the second position.

19. The method of claim 18, wherein measuring the current distance associated with the user comprises:
determining a first measurement between two facial features of a face of the user;
determining a second measurement of a rotation of the face of the user; and
using the first measurement and the second measurement to measure the current distance.

20. A computer readable storage medium having stored thereon program code executable by a computer system, the program code causing the computer system to:
generate a reference distance to classify a user in a first position or a second position;
measure a current distance associated with the user using a camera, the current distance measured using features of the user, wherein the current distance is not a measurement of a distance of the user to the camera;
determine that the user is in one of the first position or the second position based on comparing the reference distance to the current distance; and
cause a user interface to operate in a first mode when the user is in the first position and cause the user interface to operate in a second mode when the user is in the second position.
